(19) United States
(12) Patent Application Publication
(10) Pub. No.: US 2026/0308015 A1
(43) Pub. Date: Oct. 8, 2026

(54) METAL HYDROXIDE PARTICLES

(71) Applicant: Toyota Jidosha Kabushiki Kaisha, Toyota-shi (JP)

(72) Inventors: Ryosuke OHSAWA, Okazaki-shi (JP); Momoko PROCTER, Seto-shi (JP)

(73) Assignee: Toyota Jidosha Kabushiki Kaisha, Toyota-shi (JP)

(21) Appl. No.: 19/576,203

(22) Filed: Mar. 24, 2026

(30) Foreign Application Priority Data
Apr. 7, 2025 (JP) 2025-063101

(51) Int. Cl. C01G 53/84

(52) U.S. Cl. CPC C01G 53/84; C01P 2004/50; C01P 2004/61; C01P 2004/62; C01P 2006/40

(57) ABSTRACT

In the present disclosure, the above issue is addressed by providing metal hydroxide particles used as a precursor of a positive electrode active material, in which: the metal hydroxide particles are secondary particles obtained by aggregation of a plurality of primary particles; the primary particles contain a transition metal element; and when a particle size of the primary particles at a cumulative volume of 10% from a finer side is defined as D₁₀ [μm], the particle size at a cumulative volume of 50% is defined as D₅₀ [μm], and the particle size at a cumulative volume of 90% is defined as D₉₀ [μm], the primary particles satisfy 0.3≤(D₉₀−D₁₀)/D₅₀.

### CROSS-REFERENCE TO RELATED APPLICATION

This application claims priority to Japanese Patent Application No. 2025-063101 filed on Apr. 7, 2025. The disclosure of the above-identified application, including the specification, drawings, and claims, is incorporated by reference herein in its entirety.

### BACKGROUND

### 1. Technical Field

The present disclosure relates to metal hydroxide particles.

### 2. Description of Related Art

In recent years, batteries have been eagerly developed. For example, in the automotive industry, lithium ion batteries for use in battery electric vehicles (BEVs), plug-in hybrid electric vehicles (PHEVs), or hybrid electric vehicles (HEVs) have been developed. Various studies have been made on positive electrode active materials of the batteries and precursors thereof.

For example, Japanese Unexamined Patent Application Publication (Translation of PCT Application) No. 2014-506220 (JP 2014-506220 A) discloses a precursor material of an alloy oxide hydroxide represented by a predetermined chemical formula, and a lithiated cathode active material for a lithium ion battery prepared using the precursor material.

Japanese Unexamined Patent Application Publication No. 2024-086748 (JP 2024-086748 A) discloses particles of a transition metal composite hydroxide, containing a transition metal and an additive element unevenly distributed within the particles. The particles include secondary particles formed by aggregation of a plurality of primary particles. The secondary particles include a center portion disposed at a portion including the center of the secondary particles and formed by aggregation of a plurality of fine primary particles. The secondary particles include an outer peripheral portion disposed on the outer side of the center portion and formed by aggregation of plate-like primary particles that are larger than the fine primary particles. The additive element is contained at a higher concentration in the fine primary particles in the center portion than in the plate-like primary particles in the outer peripheral portion. JP 2024-086748 A also discloses a positive electrode active material for a lithium ion secondary battery, in which particles of the transition metal composite hydroxide are used as a precursor.

### SUMMARY

From the viewpoint of improving the battery performance, it is required that the rate characteristics should be good. The present disclosure has been made in view of the above circumstances, and has a main object to provide metal hydroxide particles that are used as a precursor of a positive electrode active material and capable of contributing to the fabrication of a battery having good rate characteristics.

### First Aspect

Metal hydroxide particles that are used as a precursor of a positive electrode active material, in which:
the metal hydroxide particles are secondary particles obtained by aggregation of a plurality of primary particles;
the primary particles contain a transition metal element;
when a particle size of the primary particles at a cumulative volume of 10% from a finer side is defined as D₁₀ [μm], the particle size at a cumulative volume of 50% is defined as D₅₀ [μm], and the particle size at a cumulative volume of 90% is defined as D₉₀ [μm],
the primary particles satisfy 0.3≤(D₉₀−D₁₀)/D₅₀.

### Second Aspect

In the metal hydroxide particles according to the first aspect, the primary particles may satisfy (D₉₀−D₁₀)/D₅₀≤5.0.

### Third Aspect

In the metal hydroxide particles according to the first or second aspect, the primary particles may satisfy 0.5≤/D₅₀≤5.0.

### Fourth Aspect

In the metal hydroxide particles according to any one of the first to third aspects, the primary particles may contain at least one of an Ni element, a Co element, and an Mn element as the transition metal element.

### Fifth Aspect

In the metal hydroxide particles according to the fourth aspect, the primary particles may contain the Ni element as the transition metal element; and a ratio of the Ni element in an entirety of the transition metal element may be 50 mol % or more.

According to the present disclosure, it is possible to provide metal hydroxide particles capable of contributing to the fabrication of a battery having good rate characteristics.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating metal-hydroxide particles according to the present disclosure; and

FIG. 2 is a schematic cross-sectional view illustrating a battery in the present disclosure.

### DETAILED DESCRIPTION OF EMBODIMENTS

Hereinafter, the metal hydroxide particles in the present disclosure will be described in detail. Note that the drawings shown below are examples, and the size of each part and the shape of each part may be exaggerated for ease of understanding.

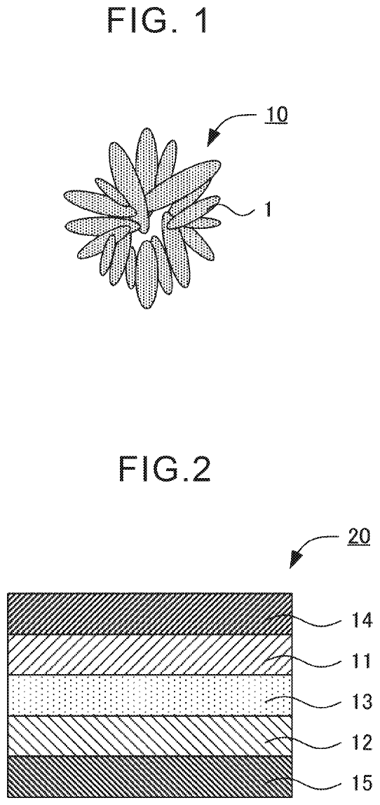

The metal hydroxide particles in the present disclosure are used as a precursor of a positive electrode active material. As shown in FIG. 1, the metal hydroxide particles 10 are secondary particles in which a plurality of primary particles 1 is aggregated. The primary particles 1 contain a transition metal element. In the primary particle 1, the cumulative particle size of 10% from the small particle side on a volume basis is D₁₀ [μm], the cumulative particle size of 50% is D₅₀ [μm], and the cumulative particle size of 90% is D₉₀ [μm]. The primary particles 1 satisfy a/D₅₀ of 0.3≤(D₉₀−D₁₀).

According to the present disclosure, since the primary particles satisfy/D₅₀ of 0.3≤(D₉₀−D₁₀), the metal-hydroxide particles can contribute to the production of a battery having good rate-characteristics.

In the positive electrode active material, it is presumed that when the particle size of the primary particles contained therein is uniform, the reaction in the entire positive electrode active material becomes uniform, and battery characteristics such as rate characteristics become favorable. However, surprisingly, the present inventors have found that the rate characteristics of the battery are improved by having a variation in the particle size of the primary particles in the positive electrode active material. This is presumed to be because, when the particle size of the primary particles is uniform, the inside of the positive electrode active material which is the secondary particles becomes dense, and it becomes difficult for the electrolyte solution to sufficiently permeate into the inside, and the diffusibility of Li ions deteriorates. The inventors of the present disclosure have found that the particle size of the primary particles of the positive electrode active material produced using the precursor particles can also be varied by having variations in the particle size of the primary particles of the positive electrode active material, and have completed the present disclosure.

### 1. Primary Particle

The primary particles satisfy a/D₅₀ of 0.3≤(D₉₀−D₁₀). The (D₉₀−D₁₀)/D₅₀ is an index indicating the size of the distribution of the entire particle based on the D₅₀. The larger the (D₉₀−D₁₀)/D₅₀, the wider the distribution and the more variable the particle size of the primary particles. The (D₉₀−D₁₀)/D₅₀ may be 0.4 or greater. The (D₉₀−D₁₀)/D₅₀ may be 0.5 or greater. The (D₉₀−D₁₀)/D₅₀ may be 0.7 or greater. The (D₉₀−D₁₀)/D₅₀ may be 0.9 or more. (D₉₀−D₁₀)/D₅₀ may be 1.0 or more. The (D₉₀−D₁₀)/D₅₀ may be 1.5 or greater. (D₉₀−D₁₀)/D₅₀ may be 2.0 or more. (D₉₀−D₁₀)/D₅₀ may be 2.3 or more. (D₉₀−D₁₀)/D₅₀ may be 2.5 or more. On the other hand, (D₉₀−D₁₀)/D₅₀, for example, is 5.0 or less, may be 4.8 or less, may be 4.0 or less, and may be 3.0 or less.

Here, D₁₀, D₅₀ and D₉₀ are particle sizes (μm) of 10% cumulative, 50% cumulative and 90% cumulative, respectively, from the small particle side by volume. D₁₀, D₅₀ and D₉₀ can be measured, for example, by small angle X-ray scattering (SAXS).

The D₅₀ is not particularly limited as long as the above equation (0.3≤(D₉₀−D₁₀)/D₅₀) is satisfied. D₅₀ is, for example, 0.5 μm or more, may be 1.0 μm or more, may be 1.2 μm or more, may be 1.5 μm or more, may be 2.4 μm or more, may be 2.5 μm or more. On the other hand, the D₅₀ is, for example, 5.0 μm or less, may be 4.5 μm or less, may be 4.0 μm or less, may be 3.5 μm or less, may be 3.0 μm or less.

The D₁₀ is not particularly limited as long as it satisfies the above equation and is smaller than the D₅₀. The D₁₀ is, for example, 0.1 μm or more and 3 μm or less. Further, the D₉₀ is not particularly limited as long as it satisfies the above equation and is larger than the D₅₀. The D₉₀ is, for example, 5 μm or more and 10 μm or less.

Particle size (D₁₀, D₅₀ and D₉₀) and particle size variations can be adjusted, for example, by changing the conditions in the crystallization method as described in the Examples below. Specifically, by adjusting the supply rate of the raw material solution containing the transition metal element and the reaction temperature in the crystallization method, the growth of the primary particles can be promoted or suppressed, and the variation in the particle size and the particle size can be adjusted. For example, increasing the feed rate and the reaction temperature can be adjusted in a direction that promotes the growth of particles, and decreasing the feed rate and the reaction temperature can be adjusted in a direction that suppresses the growth of particles. Then, as described in Examples to be described later, by alternately repeating the dropping conditions for suppressing the growth of particles and the dropping conditions for promoting the growth of particles, it is possible to adjust the variation in particle size.

The primary particles are hydroxides containing transition metal elements. Examples of the transition-metal element include an Ni element, a Co element, and an Mn element. The primary particles may contain at least one of an Ni element, a Co element, and an Mn element, and may contain two or more kinds of transition metal elements.

The primary particles preferably contain at least an Ni element as the transition-metal element. The ratio of Ni element to all of the transition metal element is, for example, 30 mol % or more, may be 50 mol %, may be 60 mol % or more, may be 70 mol % or more, may be 80 mol % or more. On the other hand, the ratio of Ni element is usually 100 mol % or less, may be 98 mol % or less, may be 95 mol % or less, may be 90 mol % or less, may be 85 mol % or less.

The primary particles may contain a Co element as a transition-metal element, or may not contain a Co element. The ratio of Co element to all of the transition-metal elements is, for example, not less than 0 mol %, may be not less than 3 mol %, may be not less than 5 mol %, and may be not less than 10 mol %. On the other hand, the ratio of Co element is, for example, not more than 30 mol %.

The primary particles may contain an Mn element as a transition-metal element, or may not contain an Mn element. The ratio of Mn element to all of the transition-metal elements is, for example, not less than 0 mol %, may be not less than 3 mol %, may be not less than 5 mol %, and may be not less than 10 mol %. On the other hand, the ratio of Mn element is, for example, not more than 30 mol %.

The primary particles may contain elements other than the transition metal element, the O element, and the H element. Examples of the other elements include metal elements belonging to Groups 12 to 14 in the periodic table. Examples of the metallic elements belonging to Groups 12 to 14 include Zn, Al, Si, Ga, Ge, In, Sn.

### 2. Metal Hydroxide Particles

The metal hydroxide particles in the present disclosure are secondary particles in which the plurality of primary particles described above are aggregated. The number of primary particles constituting the secondary particles is usually 2 or more, may be 5 or more, or may be 10 or more. On the other hand, the number of primary particles constituting the secondary particles is not particularly limited, but is, for example, 10000 or less.

A method for producing the metal hydroxide particles is not particularly limited, and examples thereof include a crystallization method as described in Examples to be described later.

The particle size of the secondary particles is, for example, 10 μm or more and 50 μm or less. Further, it is preferable that the secondary particles have a void (a space in which the primary particles do not exist) inside. The porosity of the secondary particles is, for example, 10% or more and 40% or less. The porosity of the secondary particles can be measured, for example, by performing software-based image analysis on the cross-sectional SEM image.

### 3. Positive Electrode Active Material

The metal hydroxide particles in the present disclosure are used as a precursor of a positive electrode active material. In the present disclosure, it is also possible to provide a positive electrode active material that is a calcined product of the metal hydroxide particles described above. In the positive electrode active material of the present disclosure, it is presumed that the ratio of each transition metal element in the above-described metal hydroxide particles and the structure such as the variation in the particle size and the particle size are usually maintained. That is, the present disclosure can also provide the following positive electrode active material. The positive electrode active material in the present disclosure is usually metal oxide particles.

This is a positive electrode active material used in a battery. The positive electrode active material is a secondary particle in which a plurality of primary particles is aggregated. The primary particles contain a Li element, a transition-metal element, and an O element. In the primary particles, the cumulative particle size of 10% from the small particle side on a volume basis is defined as D′₁₀ [μm], the cumulative particle size of 50% is defined as D′₅₀ [μm], and the cumulative particle size of 90% is defined as D′₉₀ [μm]. The primary particle satisfies a /D′₅₀ of 0.3≤(D′₉₀−D′₁₀).

With respect to D′₁₀, D′₅₀, D′₉₀ and the above equation, the content of D₁₀, D₅₀, D₉₀ and the above equation described in “1. Primary Particles” can be appropriately applied. The proportions of Ni, Co and Mn in the primary particles of the positive electrode active material are also the same as those described in “1. Primary particles”.

The composition of the primary particles in the positive electrode active material is not particularly limited. The composition of the primary particles in the positive electrode active material is, for example, a composition represented by the formula LiₓNiₐCo_{b}Mn_{c}O_{y} (0.1≤x≤1.5, 0.5≤a≤1.0, 0≤b≤0.3, 0≤c≤0.3, a+b+c=1.0, 1.5≤y≤2.1).

The production process of the positive electrode active material is not particularly limited, but it can be produced, for example, by adding a Li source (e.g., LiOH, Li₂CO₃) to the above-described metal hydroxide particles and firing them, as described in Examples below. The positive electrode active material is used in a battery. The battery will be described later.

### 4. Battery

In the present disclosure, a battery including a positive electrode active material layer containing the above-described positive electrode active material can also be provided. FIG. 2 is a schematic cross-sectional view illustrating a battery in the present disclosure. The battery 20 illustrated in FIG. 2 includes a positive electrode active material layer 11, a negative electrode active material layer 12, and an electrolyte layer 13 disposed between the positive electrode active material layer 11 and the negative electrode active material layer 12. The battery 20 illustrated in FIG. 2 includes a positive electrode current collector 14 that collects electrons of the positive electrode active material layer 11, and a negative electrode current collector 15 that collects electrons of the negative electrode active material layer 12. In the battery 10, the positive electrode active material layer 11 contains the above-described positive electrode active material.

### (1) Positive Electrode Active Material Layer

The positive electrode active material layer contains the above-described positive electrode active material. Since the positive electrode active material is the same as the content described in “3. Positive electrode active material”, the description thereof will be omitted. The proportion of the positive electrode active material in the positive electrode active material layer is, for example, 20 mass % or more and 95 mass % or less.

The positive electrode active material layer may optionally contain at least one of a conductive material, a binder, and an electrolyte. Examples of the conductive material include a carbon-based conductive material. Examples of the carbon-based conductive material include particulate materials such as acetylene black (AB) and Ketjen black (KB), and fibrous materials such as gas phase carbon fibers (VGCF), carbon nanotubes (CNT), and carbon nanofibers (CNF). Examples of the binder include rubber-based binders such as styrene-butadiene rubber (SBR) and butadiene rubber (BR), polycarboxylic acid-based binders such as carboxymethyl cellulose, and fluoride-based binders such as polyvinylidene fluoride (PVdF). As the electrolyte, an electrolyte described in “(3) Electrolyte layer” can be cited.

### (2) Negative Electrode Active Material Layer

The negative electrode active material layer contains at least a negative electrode active material. Examples of the negative electrode active material include a carbon-based active material, a Li active material, a Si active material, and an oxide-based active material.

Examples of the carbon-based active material include graphite, soft carbon, and hard carbon. The graphite may be natural graphite or artificial graphite. Examples of Li active material include Li, Li alloys. Examples of Li alloy include Li—Si alloys. Examples of Si active material include Si, SiC complex active materials, Si alloys, and Si oxides. Examples of SiC complex active material include an active material in which Si or Si is supported on a carbon-support. Examples of the oxide-based active material include lithium titanate such as Li₄Ti₅O₁₂.

The negative electrode active material layer may contain at least one of a conductive material, a binder, and an electrolyte. The conductive material, the binder, and the electrolyte are the same as those described in “(1) the positive electrode active material layer”.

### (3) Electrolyte Layer

The electrolyte layer is a layer disposed between the positive electrode active material layer and the negative electrode active material layer, and contains at least an electrolyte. The electrolyte is, for example, a liquid electrolyte (electrolytic solution).

Examples of the electrolytic solution include a non-aqueous electrolytic solution. The non-aqueous electrolytic solution contains, for example, a lithium salt and a non-aqueous solvent. Examples of the lithium salt include inorganic lithium salts such as LiPF₆, LiBF₄, LiClO₄, and LiAsF₆ and organic lithium salts such as LiCF₃SO₃, LiN(SO₂CF₃)₂, LiN(SO₂C₂F₅)₂, and LiC(SO₂CF₃)₃.

Examples of the non-aqueous solvent include carbonate-based solvents such as ethylene carbonate (EC), propylene carbonate (PC), butylene carbonate (BC), dimethyl carbonate (DMC), diethyl carbonate (DEC), and ethyl methyl carbonate (EMC).

The electrolyte layer may include a separator that impregnates the above-described electrolyte solution. The material of the separator may be a conventionally known material.

### (4) Battery

The battery preferably includes a positive electrode current collector that collects the positive electrode active material layer and a negative electrode current collector that collects the negative electrode active layer. Examples of the positive electrode current collector include SUS, aluminum, nickel, iron, titanium, and carbon. On the other hand, examples of the negative electrode current collector include SUS, copper, nickel, and carbon. Further, the battery in the present disclosure may have an exterior body that houses a power generation element (a positive electrode active material layer, an electrolyte layer, and a negative electrode active material layer). Examples of the exterior body include a case-type exterior body and a laminate-type exterior body.

The battery in the present disclosure is typically a lithium-ion battery. The battery in the present disclosure may be a primary battery or a secondary battery, but is preferably a secondary battery. This is because the battery can be repeatedly charged and discharged, and is useful, for example, as an in-vehicle battery. Applications of lithium-ion batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Further, the battery may be used as a power source for a moving object (for example, a railway, a ship, or an aircraft) other than the vehicle, or may be used as a power source for an electric product such as an information processing apparatus.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Comparative Example 1

### Preparation of Precursor Particles

Precursor particles (metal hydroxide particles) of the positive electrode active material were prepared in the following manner.

### Preparation of Raw Aqueous Solution

First, as a raw material, NiSO₄, CoSO₄ and MnSO₄ were prepared, and these were dissolved in ion-exchanged water to prepare an aqueous raw material solution. The ratio of Ni and Mn in the raw aqueous solution was Ni:Co:Mn=8:1:1 in molar ratio. The concentration of the raw material aqueous solution (ratio of all raw materials to the raw material aqueous solution) was 30% by mass.

### Crystallization

A fixed amount of NH₃ aqueous solution was placed in the reaction vessel, and the inside of the reaction vessel was nitrogen-substituted while stirring with a stirrer. An aqueous NaOH solution was added to the reactor, pH was kept alkaline (pH=11), and an aqueous raw material solution and an aqueous NH₃ solution were added dropwise for 3 hours while being controlled to a constant temperature. The feed rate of the raw aqueous solution was 5 mL/min and the reactivity was 40° C. Further, for the NH₃ density, the drip rate of the NH₃ aqueous solution was adjusted to be constantly 15 g/L. As a result, a crystallized material (precipitate) was obtained.

### Washing and Drying

The precipitate was collected by filtration and washed with ion-exchanged water. Thereafter, drying was performed at 120° C. for 16 hours to obtain precursor particles.

### Preparation of Positive Electrode Active Material

A mortar was used to mix the precursor grains and Li source (LiOH). The ratio (molar ratio) of Li to the sum of the transition-metal elements contained in the precursor-particles was 1.1. The resulting mixture was calcined in a muffle furnace at 900° C. for 10 hours. The obtained fired body was crushed using a jet mill to adjust the particle size, thereby obtaining a positive electrode active material.

### Preparation of Batteries

A battery was prepared using the obtained positive electrode active material. Specifically, the positive electrode mixture paste was applied to the surface of the metal foil, which is a positive electrode current collector, using a film applicator with a film thickness adjusting function (manufactured by All Grid Co., Ltd.). The positive electrode mixture paste contains a positive electrode active material, a conductive material (acetylene black), and a binder (polyvinylidene fluoride) in a mass ratio of positive electrode active material:conductive material:binder=88:10:2. Thereafter, the mixture was dried in a dryer at 80° C. for 5 minutes to obtain a positive electrode having a positive electrode current collector and a positive electrode active material layer.

Next, the negative electrode mixture paste was applied to the surface of the metal foil serving as the negative electrode current collector using a film applicator with a film thickness adjusting function (manufactured by All Grid Co., Ltd.). The negative electrode mixture paste contains a negative electrode active material (natural graphite) and binders (SBR and CMC). Thereafter, the negative electrode was dried in a dryer at 80° C. for 5 minutes to obtain a negative electrode having a negative electrode current collector and a negative electrode active material layer. Next, LiPF₆ solutions of concentrated 1M were prepared as electrolyte solutions. As the solvent of the electrolyte solution, a mixed solvent obtained by mixing ethylene carbonate (EC), dimethyl carbonate (DMC), and ethyl methyl carbonate (EMC) in a volume ratio of EC:DMC:EMC of 3:4:3 was used. A wound cylindrical battery was obtained using the positive electrode, the negative electrode, and the electrolytic solution.

### Example 1

Precursor particles were prepared in the same manner as in Comparative Example 1 except that the dropping conditions were changed as follows in the crystallization.

The first dropping treatment for 10 minutes with the feed rate as a 4 mL/min and the reaction temperature as 35° C., and the second dropping treatment for 10 minutes with the feed rate as a 6 mL/min and the reaction temperature as 45° C. were performed in one cycle. The cycle was repeated until the total drip time was 3 hours.

A positive electrode active material and a battery were obtained in the same manner as in Comparative Example 1 except that the obtained precursor particles were used.

### Example 2

Precursor particles were prepared in the same manner as in Comparative Example 1 except that the dropping conditions were changed as follows in the crystallization.

The first dropping treatment for 10 minutes with the feed rate as a 3 mL/min and the reaction temperature as 30° C., and the second dropping treatment for 10 minutes with the feed rate as a 7 mL/min and the reaction temperature as 50° C. were performed in one cycle. The cycle was repeated until the total drip time was 3 hours.

A positive electrode active material and a battery were obtained in the same manner as in Comparative Example 1 except that the obtained precursor particles were used.

### Example 3

Precursor particles were prepared in the same manner as in Comparative Example 1 except that the dropping conditions were changed as follows in the crystallization.

The first dropping treatment for 10 minutes with the feed rate as a 2.5 mL/min and the reaction temperature as 30° C., and the second dropping treatment for 10 minutes with the feed rate as a 7.5 mL/min and the reaction temperature as 55° C. were performed in one cycle. The cycle was repeated until the total drip time was 3 hours.

A positive electrode active material and a battery were obtained in the same manner as in Comparative Example 1 except that the obtained precursor particles were used.

### Example 4

Precursor particles were prepared in the same manner as in Comparative Example 1 except that the dropping conditions were changed as follows in the crystallization.

The first dropping treatment for 10 minutes with the feed rate as a 2 mL/min and the reaction temperature as 30° C., and the second dropping treatment for 10 minutes with the feed rate as 8 mL/min and the reaction temperature as 60° C. were performed in one cycle. The cycle was repeated until the total drip time was 3 hours.

A positive electrode active material and a battery were obtained in the same manner as in Comparative Example 1 except that the obtained precursor particles were used.

### Evaluation

### Particle Size Measurement

The particle size (D₁₀, D₅₀ and D₉₀) was measured from the small-angle X-ray scattering method (SAXS) with respect to the metal hydroxide particles (precursor particles of the positive electrode active material) prepared in Comparative Example 1 and Examples 1 to 4. /D₅₀ (D₉₀−D₁₀) was calculated from the obtained values. The results are shown in Table 1. Incidentally, in SAXS, using a SmartLab manufactured by Rigaku Co., measured 0°≤2θ≤10°, fitting was performed using analysis software attached to the device. Then, D₁₀, D₅₀, and D₉₀ were obtained from the obtained profile.

### Rate Test

Rate characteristics were evaluated for the batteries prepared in Comparative Example 1 and Examples 1 to 4. Specifically, in the voltage range 2.5 V to 4.25 V, the current rates were charged and discharged with 0.1 C or 1 C, and the discharge capacity in 0.1 C and the discharge capacity in 1 C were measured. Then, the ratio (%) of the discharge capacity in 1 C to the discharge capacity in 0.1 C was calculated, and the rate properties were compared. The results are shown in Table 1.

TABLE 1

| | | | | | Particle size | | Rate characteristics |
|---|---|---|---|---|---|---|---|
| | Molar ratio | | | | D₅₀ | | 1 C/0.1 C |
| | Li | Ni | Co | Mn | (μm) | (D₉₀ − D₁₀)/D₅₀ | (%) |
| Comparative | 1.1 | 0.8 | 0.1 | 0.1 | 0.4 | 0.2 | 67 |
| Example 1 | | | | | | | |
| Example 1 | 1.1 | 0.8 | 0.1 | 0.1 | 0.5 | 0.3 | 78 |
| Example 2 | 1.1 | 0.8 | 0.1 | 0.1 | 1.2 | 0.9 | 79 |
| Example 3 | 1.1 | 0.8 | 0.1 | 0.1 | 2.4 | 2.3 | 81 |
| Example 4 | 1.1 | 0.8 | 0.1 | 0.1 | 4.5 | 4.8 | 83 |

As shown in Table 1, it was confirmed that by using the positive electrode active material produced from the metal hydroxide particles in the present disclosure in a battery, the rate characteristics of the battery were improved. Since the positive electrode active material is produced by firing the metal hydroxide particles, it is presumed that the ratio of the transition metal elements in the metal hydroxide particles and the particle size of the primary particles (D₁₀, D₅₀, and D₉₀) are maintained.

What is claimed is:

1. Metal hydroxide particles that are used as a precursor of a positive electrode active material, wherein:
the metal hydroxide particles are secondary particles obtained by aggregation of a plurality of primary particles;
the primary particles contain a transition metal element; and
when a particle size of the primary particles at a cumulative volume of 10% from a finer side is defined as D₁₀ [μm], the particle size at a cumulative volume of 50% is defined as D₅₀ [μm], and the particle size at a cumulative volume of 90% is defined as D₉₀ [μm], the primary particles satisfy 0.3≤(D₉₀−D₁₀)/D₅₀.

2. The metal hydroxide particles according to claim 1, wherein the primary particles satisfy (D₉₀−D₁₀)/D₅₀≤5.0.

3. The metal hydroxide particles according to claim 1, wherein the primary particles satisfy 0.5≤/D₅₀≤5.0.

4. The metal hydroxide particles according to claim 1, wherein the primary particles contain at least one of an Ni element, a Co element, and an Mn element as the transition metal element.

5. The metal hydroxide particles according to claim 4, wherein:
the primary particles contain the Ni element as the transition metal element; and
a ratio of the Ni element in an entirety of the transition metal element is 50 mol % or more.
